(19) United States
(12) Patent Application Publication
(10) Pub. No.: US 2006/0082069 A1
(43) Pub. Date: Apr. 20, 2006

(54) Bearing-supported mechanical seal for progressive cavity pumps

(75) Inventor: Claudio Malavazi, Sao Paulo (BR)

Correspondence Address: NORRIS, MCLAUGHLIN & MARCUS, 875 THIRD AVE, 18TH FLOOR, NEW YORK, NY, 10022, US

(73) Assignee: Malavazi Vedacoes Industriais Ltda, Chacara Sao Benito/Valinhos (BR)

(21) Appl. No.: 11/245,936

(22) Filed: Oct. 7, 2005

(30) Foreign Application Priority Data
Oct. 14, 2004 (BR) PI 0404380-4

(51) Int. Cl. E21B 33/00; F16C 33/76

(52) U.S. Cl. 277/322; 384/477

(57) ABSTRACT

A The bearing-supported mechanical seal for a progressive including a cylindrical body (1), manufactured of steel or other materials (optional), with an internal centered sleeve (2), which fits perfectly the pump shaft/stem (3). It is equipped with two O-ring sets (4) for adjustment and sealing. The body (1) has housings for bearings (5), equipped with one or more roller bearings that will support all the stem reversions. The bearing-supported assembly seals are made by retainers (7A and 7B), installed on the roller bearing edges. The sealing assembly has two stationary seats (17) and one rotary seat (19), which has a closed lubrication system, composed by one reservoir (22), two communicating tubes (23), one pressure gauge (24) that operates under atmospheric pressure, and one pressure switch (25). The reservoir also has a drain (26) for replacing the lubricating oil and one relief valve (27), which could be opened or not. In the lower region of the mechanical seal, there is a reel for maintenance (28), equipped with side covers (29) and a supporting device (30) of the pump shaft/stem, thus significantly facilitating the disassembly of their components.

### BACKGROUND OF THE INVENTION

The present invention Patent concerns a bearing-supported mechanical seal for a progressive cavity pump, used in petroleum well exploration and refineries, which characteristics provide total leak elimination, with product loss to the environment, and also provides excellent strength, robustness and tightness, thus offering technical and functional benefits, inherent to its applicability and replacing the current conventional gaskets used for this purpose, and increasing significantly the component's overlife, bringing higher efficiency to the equipment.

The progressive cavity pumps are acknowledged in the oil industry as the most strong and efficient for carrying raw oil in high or low-viscosity means, with water, salt or gas incorporated, whether or not with suspended abrasive solids, at low or high temperatures. But, their sealing system does not support large efforts or excessive vibration, and are worn with the consequent damage of the component sealing, thus reducing their lifetime, and requiring the sealing replacement and change.

The leakage of this raw oil by the gaskets impairs significantly the environment, leading some companies to use in the region nearby the equipment, a large quantity of sand spread on the ground in order to absorb the wasted product. From time to time, this sand is replaced and removed for further decontamination. This requires a lot of work with high maintenance costs.

Despite the advanced technology of the materials employed in the current sealing systems, the industry has not yet achieved a better efficiency with a product that could support the severe and critical operation conditions of the progressive cavity pumps.

### SUMMARY OF THE INVENTION

With this purpose in mind, the present invention has succeeded in providing, in an intelligent and innovating way, a product able to provide technical and functional benefits, with high efficiency and extended lifetime, which fully meets the goals proposed.

The bearing-supported mechanical seal for progressive cavity pumps of this invention, has also a special construction in order not to require any technical change in the current lift stations in operation, because the seal adapts perfectly to the nozzles and shafts/stems of the existing pumps.

The system has two bearings and dual sealing, with a closed lubrication reservoir, which depending on the pressure increase within the system and the indication from a pressure gauge will activate a pressure switch that will turn off the progressive cavity pump's motor. Thus, in case of any raw oil leakage in the system, the well will be automatically deactivated, without impairing the environment, until the maintenance teams are able to solve the problem.

In order to ensure full operating safety, and depending on the load to which the well is subject to, the bearing is equipped with two or more roller bearings that will support all the stem reversions, without losing the concentricity and thus preventing harmful oscillations in the mechanical seal region.

Another significant benefit from using the bearing-supported mechanical seal, when compared to the current gaskets, is that its installation is simple and fast, without requiring adjustments of the assembly at field, thus significantly reducing the labor force required for maintenance. Also, an additional relevant factor in this project is that a reel provided with side covers has been adapted in the region beneath the bearing-supported mechanical seal. These covers will be removed when maintaining the pump to enable introducing a supporting device for the pump shaft/stem, thus facilitating the disassembly of their components.

### BRIEF DESCRIPTION OF THE DRAWINGS

The bearing-supported mechanical seal for progressive cavity pumps and its application will be known by reading the description provided in the attached drawings, to which we refer in order to better clarify the detailed description below, where:

FIG. 1: illustrates the front elevation view of the bearing-supported mechanical seal for progressive cavity pumps;

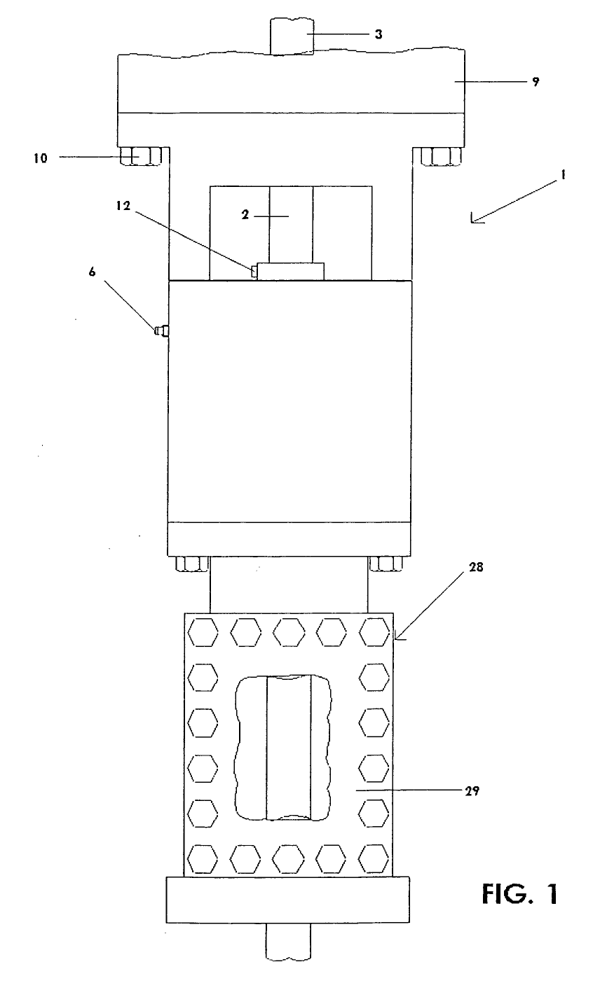

FIG. 2: illustrates the plan view of the bearing-supported mechanical seal for progressive cavity pumps, by indicating the A-A Section;

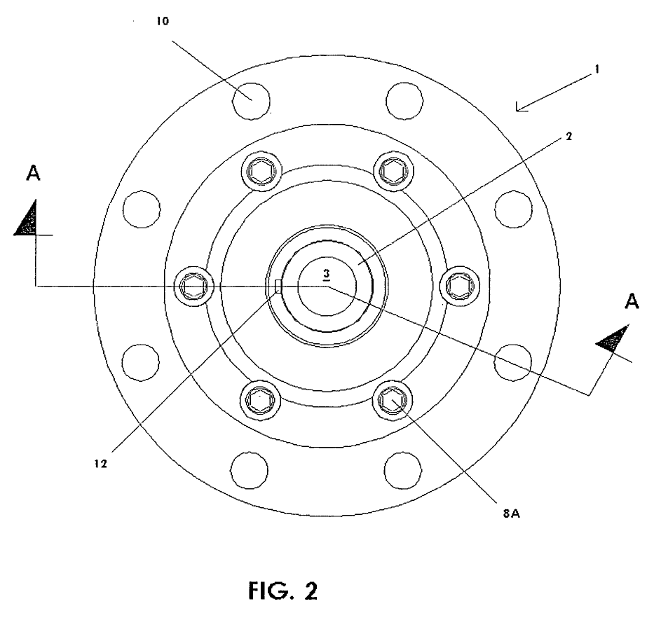

FIG. 3: illustrates the A-A section view of the Bearing-Supported Mechanical Seal for Progressive Cavity Pumps, assembled in its housing with the pump transmission shaft;

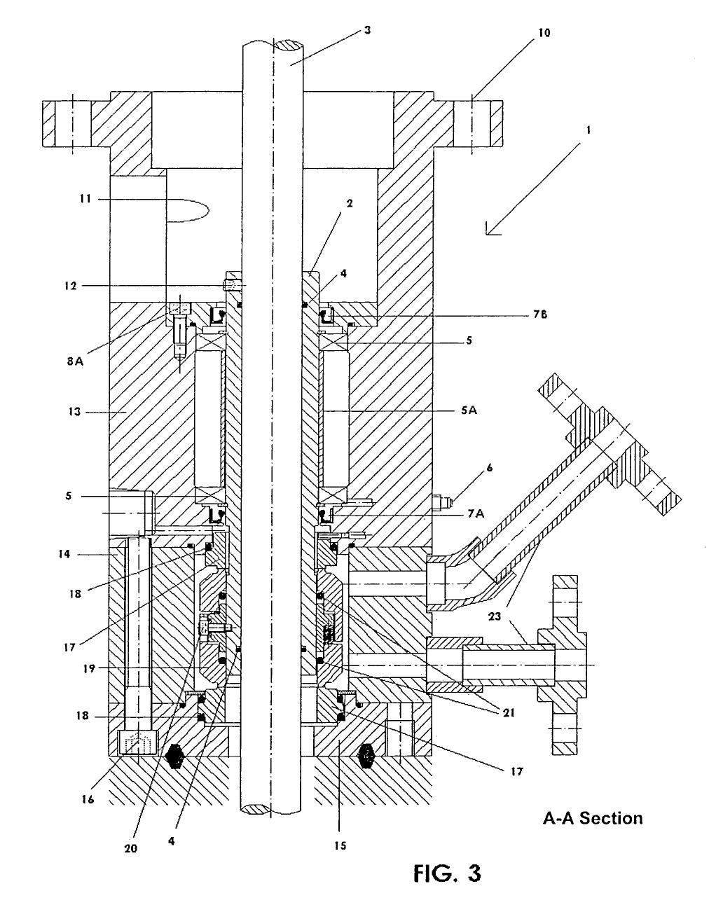

FIG. 4: illustrates the B-B section view, detailing the set of components of the progressive cavity pump with the application of the bearing-supported mechanical seal;

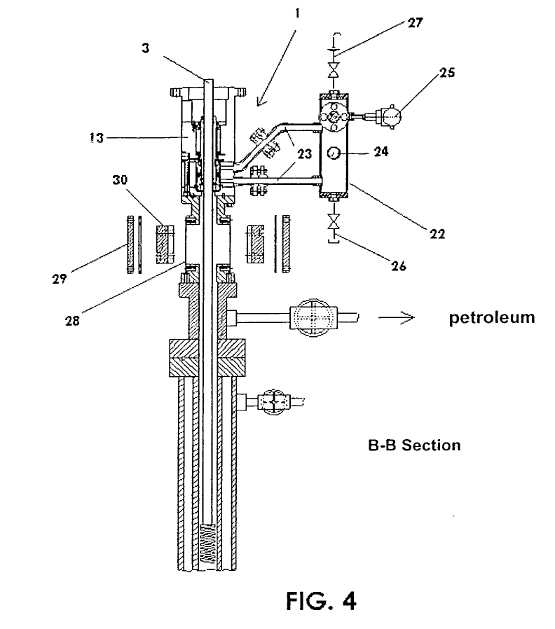

FIG. 5: illustrates the side elevation view, showing the whole assembly of moto-reducer/pump/bearing-supported mechanical seal/pump base/shaft, etc; and

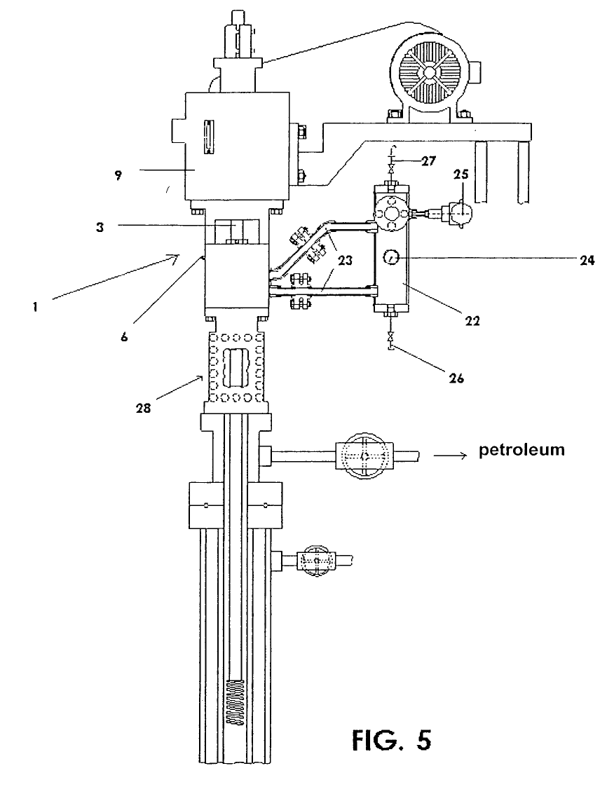

FIG. 6: illustrates the detailed view of the reel without the covers. The shaft/stem supporting device can also be observed.

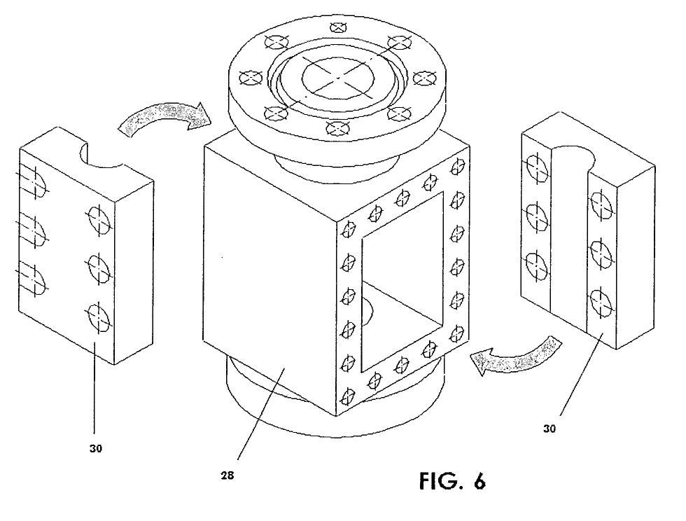

### DETAILED DESCRIPTION OF THE EMBODIMENTS

According to these illustrations and the details provided, the bearing-supported mechanical seal for progressive cavity pumps herein proposed is constituted by one (1) cylindrical body, manufactured in steel or other material (optional), internally centered, with a sleeve (2) that fits perfectly the pump shaft/stem (3), and with two O-ring sets (4) for adjustment and sealing.

The body (1) has internal housings for bearings (5), equipped with two or more roller bearings, which have a spacer (5A) between each other and that will support all the stem reversions, which main feature is centering the sealing assembly to the pump stem. This is designed for a dynamic radial effort above the most critical operation condition, when the stem reversion occurs, reaching an average speed of 1000 RPM. Even so, the assembly does not lose concentricity and the shaft in the Mechanical Seal region is not subject to oscillations.

The bearings have an independent lubrication system by external grease fitting (6). The bearing-supported assembly seals are made via retainers (7A and 7B) installed on the roller bearing edges, with a flange (8) on the upper region, fastened by internal Allen screws (8A).

The fastening of the bearing-supported mechanical seal to the moto-reducer's pump nozzle (9) is made via flanges fastened by hexagonal-head screws (10).

Between the motor-reducer's pump nozzle (9) and the own sealing assembly body (1), there is a hollow external opening (11). The sleeve (2) is fastened to the pump shaft/stem (3) by a screw (12), which is in charge of keeping the rotary assemblies firmly linked together. This system is very simple and fast for assembling and disassembling.

The bearing-supported mechanical seal is divided in three parts, main body (13), intermediate body (14) and cover (15). The two latter parts are fastened to the main body by Allen screws (16), which keep the assembly compacted.

Considering a maximum speed of 400 RPM for the pump shaft, the peripheral speeds have been estimated to 1.6 meters/second in dry conditions, which maximum value allowed is 2.0 meters/second, and 25 meters/second in wet conditions, with allowance of 0.4 meters/second, which does not cause any damage or overheating among the components.

Maximum working pressures and temperatures for the Bearing-Supported Mechanical Seal's components are 40 Kgf/cm² and 180° C., respectively.

The sealing assembly, which is positioned into the intermediate body (14), has also a series of important components that incorporate each other for providing absolute tightness to the system. With minimum clearances designed among the components, and positioned for ensuring radial torque, the stationary seats (17) are fastened by O-rings (18) in their housings, with the rotary seat (19) in the center, which is fastened to the sleeve (2) by screw (20) and O-rings (21). The contact surfaces of the stationary seats (17) and the rotary seat (19) are lapped, which ensures perfect sliding between them, forming a double sealing in a single chamber that has a closed lubrication system of the assembly, thus complying with the specific national and international standards of the petrochemical industry.

The sealing lubrication reservoir (22) is composed by the communicating tubes (23), one pressure gauge (24) operating under atmospheric pressure, and one pressure switch (25). In case of any leakage in the sealing chamber, the pressure gauge will indicate the raw oil (petroleum) pressure, thus activating the pressure switch in charge of immediately turning off the progressive cavity pump's motor. The reservoir is also constituted by a drain (26) for replacing the lubrication oil and a relief valve (27), which could be opened or not.

In the lower region of the bearing-supported mechanical seal, there is a reel for maintenance (28), equipped with bolted side covers (29), which will be removed when the well is under maintenance, by introducing a supporting device (30) of the pump shaft/stem, thus significantly facilitating the disassembly of its components. This device is split, containing screws for its fastening, and specifically aims at supporting and locking the pump shaft/stem when replacing the mechanical seal, and/or facilitating the motor-reducer assembly maintenance.

Depending on the load imposed on the well, the progressive cavity pump could be equipped with one or two roller bearings and the mechanical seal could be single or dual, which will provide higher operating warranty and safety.

Thus, the bearing-supported mechanical seal for progressive cavity pumps fully meets the proposed goals, thus fulfilling in a practical, efficient and safe way the sealing application it is aimed at, and enabling a longer lifetime with its unique and innovating features, and providing essential new requirements.

1. A bearing-supported mechanical seal for a progressive pump, comprising
a cylindrical body (1),
a sleeve (2) being axially centered which is fitted into the pump shaft/stem (3), having two O-ring sets (4) for adjustment and sealing;
the body (1) includes a bearing housing (5) equipped with one or more roller bearings that support the stem reversions;
a bearing-supported assembly seals are provided via retainers (7A and 7B) and installed on roller bearing edges;
the sealing assembly has two stationary seats (17) and one rotary seat (19), including a closed lubrication system with a reservoir (22), communicating tubes (23), a pressure gauge (24) operating under atmospheric pressure, and a pressure switch (25);
the reservoir includes a drain (26) for replacing lubrication oil and a relief valve (27);
a reel for maintenance (28), equipped with side covers (29), and a supporting device (30) of the pump shaft/stem, for facilitating the disassembly.

2. The bearing-supported mechanical seal for a progressive pump according to claim 1,
wherein the body (1) has an internal housing for bearings (5), which have a spacer (5A) between each other, equipped with at least one roller bearing for supporting the shaft/stem reversions, and centering the sealing assembly to the pump stem.

3. The bearing-supported mechanical seal for a progressive pump according to claim 2,
wherein the bearings have an independent lubrication system, via external grease fittings (6);
the bearing-supported assembly seals are made by retainers (7A and 7B), installed on the roller-bearing edges, with a flange (8) on the upper region, fastened by internal Allen screws (8A).

4. The bearing-supported mechanical seal for a progressive pump according to claim 1,
wherein the fastening of the bearing-supported mechanical seal to the motor-reducer's pump nozzle (9) is made by flanges, fastened by hexagonal-head screws (10);
between the motor-reducer's pump nozzle (9) and the own sealing assembly body (1), a hollow external opening (11) is provided.

5. The bearing-supported mechanical seal for a progressive pump according to claim 1,
wherein the sleeve fastening (2) to the pump shaft/stem (3) is made by a screw (12), which keeps the rotary assemblies firmly linked together.

6. The bearing-supported mechanical seal for a progressive pump according to claim 1,
wherein the bearing-supported seal is divided in three parts, main body (13), intermediate body (14) and cover (15);
the body (14) and the cover (15) are fastened to the main body by Allen screws (16), for compacting the assembly.

7. The bearing-supported mechanical seal for a progressive pump according to claim 6,
wherein the sealing assembly, which is positioned into the intermediate body (14), has minimum clearances designed among the components, and positioned for ensuring radial torque;
the stationary seats (17) are fastened by O-rings (18) in their housings, with a centered rotary seat (19), which is fastened to the sleeve (2) by screw (20) and O-rings (21);
the contact surfaces of the stationary seats (17) and the rotary seat (19) are lapped, for a sliding fit, thereby forming dual sealing in a single chamber, which has a closed lubrication system of the assembly.

8. The bearing-supported mechanical seal for a progressive pump according to claim 7,
wherein the sealing lubrication reservoir (22) is composed by two communicating tubes (23),
a pressure gauge (24) that operates under atmospheric pressure,
a pressure switch (25),
a drain (26) for replacing the lubricating oil, and a relief valve (27).

9. The bearing-supported mechanical seal for a progressive pump according to claim 1,
wherein in the lower region of the bearing-supported mechanical seal there is a reel for maintenance (28), equipped with bolted side covers (29), which are capable of being removed when the well is maintained, by introducing a supporting device (30) of the pump shaft/stem;
the cover is split and includes fastening screws for facilitating disassembly.

10. The bearing-supported mechanical seal for a progressive pump according to claim 1,
wherein, depending on the load imposed to the well, the progressive cavity pump is capable of being equipped with at least one roller bearing and the mechanical seal is capable of being a single seal or a dual seal.

11. The bearing-supported mechanical seal for a progressive pump according to claim 1, wherein the cylindrical body (1) is manufactured of steel.
